(19) United States
(12) Patent Application Publication
(10) Pub. No.: US 2017/0362404 A1
(43) Pub. Date: Dec. 21, 2017

(54) SYNTACTIC FOAM, PROCESS OF ITS PREPARATION AND BUOYANCY MATERIAL INCLUDING THE SAME

(71) Applicant: Bardot Group, La Ciotat (FR)

(72) Inventors: Guy BARDOT, La Ciotat (FR); Xavier Pace, Marseille (FR)

(21) Appl. No.: 15/533,351

(22) PCT Filed: Nov. 27, 2015
(86) PCT No.: PCT/IB2015/059174

§ 371 Date: Jun. 5, 2017

Related U.S. Application Data
(60) Provisional application No. 62/086,796, filed on Dec. 3, 2014.

(51) Int. Cl. C08J 9/32; B29C 39/00; B29B 7/90; B29K 75/00; B29L 23/00; B29K 105/04

(52) U.S. Cl. CPC C08J 9/32; B29C 39/006; B29B 7/90; C08J 2363/00; B29L 2023/22; B29K 2105/04; B29K 2075/00; C08J 2363/02; C08J 2375/04; B29K 2995/0063

(57) ABSTRACT

Some embodiments are directed to a process for making a syntactic foam. Some other embodiments are directed to a process for manufacturing a buoyancy material including an outer shell and a syntactic foam. Still other embodiments are directed to the syntactic foam (or buoyancy foam) obtainable by this process. Some other embodiments are directed to a process of undersea extraction of oil including: using the syntactic. Still other embodiments are directed to an undersea extracting pipeline including a pipeline, and either the syntactic foam or the buoyancy material.

### CROSS REFERENCE TO RELATED APPLICATIONS

This application is a National Phase filing under 35 C.F.R. §371 of and claims priority to PCT Patent Application No.: PCT/162015/059174, filed on Nov. 27, 2015, which claims the priority benefit under 35 U.S.C. §119 of U.S. Provisional Application No. 62/086,796, filed on Dec. 3, 2014, the contents of which are hereby incorporated in their entireties by reference.

### BACKGROUND

Some embodiments relate to a process for making a syntactic foam, and the obtainable syntactic foam, as well as a process for manufacturing a buoyancy material including an outer shell and a syntactic foam, and the buoyancy material.

The embodiments have applications in many fields, especially in the domains of underwater equipment.

In the description given hereunder, the references in square brackets ([ ]) refer to the list of references given at the end of the text.

In offshore oil and gas production, flexible pipe and umbilicals require the use of buoyancy to reduce topside or tension loads to achieve particular configurations which include lazy, steep, pliant and W-wave. Deepwater projects require modules to be designed for operating depths in excess of 3000 msw (meters of sea water) where substantially larger modules, high loads and buoyant materials resistant to extreme hydrostatic pressure are demanded.

The buoyancy, which is the ability of a body to float in a liquid or to rise in a fluid, and depends on the vertical ascending force pushing the submerged object to the surface, is an important pre-requisite to take into account when manufacturing undersea or underwater installations. This buoyancy material must be relatively impermeable to water and must be capable of withstanding pressures of the magnitude encountered in deep sea environments, for example at 1500 meters below the surface. It is also important that the buoyancy material should be of low density because relatively high-density buoyancy materials require a great many pounds of buoyancy material for a given requirement of pounds buoyancy, pounds buoyancy being the difference in weight between the buoyant material and the weight of sea water of the same volume.

Furthermore, another parameter to take into account is the aging of the material. Indeed, permanent deformation of the undersea or underwater installations due to solicitations below the yield stress and maintained for long period of time has to be controlled in order to predict the service life (i.e. the period of time during which the equipment is expected to be fully functional) of the product.

Fatigue of the material, which designates the failure of a material at stress levels lower than material strength when loading are repeated (cyclic loading) is also to considered. Generally speaking, fatigue is considered to be involved for number of cycle over 5.

Lastly, the phenomenon of aging of the material, the compounds contained herein and their interfaces is a real shortcoming to take into consideration for underwater equipment. Indeed, polymers undergo irreversible changes in their properties under the action of fresh or sea water: effect could be aging, absorption of water, adjuvant migration, crack of the surface, hydrolysis, osmosis, and/or solubility of the polymer. Aging manifests itself in a deterioration of the mechanical characteristics of polymers, compounds contained herein and their interfaces and sometimes result in destruction of the polymer and/compounds. The resistance of polymers to aging in many cases allows predicting the service life and/or lifetime of polymer articles.

Some buoyancy materials have been proposed in the past, as by document U.S. Pat. No. 3,622,437 ([1]), that includes a plurality of molded hollow bodies of thermoplastic resin having a circular cross section in at least one plane and a total specific gravity less than one, and a syntactic foam in which said bodies are encased, the foam having a specific gravity less than one.

### SUMMARY

However, there is still a need in processes for making a syntactic foam and buoyancy materials that are suitable for an easy industrialized production.

Some embodiments make it possible to improve or enhance these needs by a process for making a syntactic foam, and thereafter buoyancy materials.

Advantageously, the process of the invention allows casting large (more than 3 m³) and small pieces compared to the classical casting process, depending on the choice of the user.

The syntactic foam and the buoyancy materials including the syntactic foam are honorable in the long term and have limited desorption of substances in the environment during their use, even in undersea environment, and even at high depths underwater environments.

The syntactic foam of the invention is made from a combination several fillers incorporate in a curable liquid resin, for example an epoxy matrix.

Syntactic foam of the invention benefits are:
Low density,
Strong, withstanding the pressure under water,
Insulation proprieties,
Stable over years (Low and controlled buoyancy loss). Especially, the aging of the different fillers in water is low and controlled,

Used in subsea condition in order to provide:
Buoyancy Uplift, in order to reduce an equipment weight in sea water during the installation or permanently,
Wet Insulation in order to insulate pipe.

Some embodiments relate to a process for making a syntactic foam including the steps below:
a) Mixing together a determined amount of a curable liquid resin monomer or prepolymer and a polymerization initiator in order to obtain an operable curable liquid resin;
b) Mixing at a determined temperature range the operable curable liquid resin with a determined amount of at least one type of low density micro-elements, said micro-elements being comprised in a sphere having a diameter comprised from 1 μm to 1 mm and being introduced continuously in the operable curable liquid resin and at a constant volumetric and/or mass flow rate, while limiting breakage of micro-elements;
c) Homogenizing at a determined temperature range and degasing the mixture of operable curable liquid resin and micro-elements in order to obtain an intermediate syntactic foam;
d) Casting at a determined temperature range the intermediate syntactic foam in a container optionally including a determined amount of macro-elements being comprised in a sphere of a diameter comprised from 1 mm to 10 cm; and
e) Hardening the operable curable liquid resin;
   wherein the temperature is regulated, in one or more of step(s) a) to e), to control and limit the exothermic peak during step e), thereby obtaining the syntactic foam within the container.

“An curable liquid resin monomer or prepolymer” means, in the sense of the present invention, any liquid or viscous polymer that is in a liquid state, at room temperature, before curing, and are capable of hardening permanently. They may be of several classes:
Some are manufactured by esterification or soaping of organic compounds.
Some are thermosetting plastics in which the term “resin” can be applied to the reactant or product, or both. “Resin” may be applied to one of two monomers in a copolymer (the other being called a “hardener”, as in epoxy resins). In case of epoxy resin, It may be chosen in the group including epoxy bisphenol A diglycidyl ether based resin, Bisphenol F epoxy resin, Novolac epoxy resin as epoxy phenol novolacs (EPN) and epoxy cresol novolacs (ECN), Aliphatic epoxy resin as glycidyl epoxy resins and cycloaliphatic epoxides, e.g. dodecanol glycidyl ether, diglycidyl ester of hexahydrophthalic acid or trimethylolpropane triglycidyl ether, Glycidylamine epoxy resin and methyl methacrylate resin.
Some are polyurethane resins which consist of a polymer composed of a chain of organic units joined by carbamate (urethane) links. They can be thermosetting polymers that do not melt when heated, or thermoplastic polyurethane resins.
Some are dicyclopentadiene (DCPD), which is a thermoset resin, Metton® (Materia Inc., Pasadena, Calif.), and Pentam® (Materia Inc., Pasadena, Calif.), this list not being limitative.

In step a) of the process for making a syntactic foam, the determined amount of a curable liquid resin monomer or prepolymer is the amount necessary to obtain a desired quantity of operable curable resin.

“Polymerization initiators” means, in the sense of the invention, any co-reactant allowing the setting or the beginning of the setting reaction of the curable liquid resin monomer or prepolymer when mixture of the curable liquid resin monomer or prepolymer and the polymerization initiator are in hardening conditions. The determined amount of polymerization initiator is the amount for obtaining, once the mixture is placed in hardening conditions, the setting the curable liquid resin monomer or prepolymer. The polymerization initiator may be selected depending on the kind of the curable liquid resin monomer or prepolymer. It can be selected in the group including polyfunctional amines, acids, acid anhydrides, phenols, alcohols, thiols, and polyols. For example, when the curable liquid resin monomer or prepolymer is polyurethane, the polymerization initiator may be polyol. When the liquid resin monomer or prepolymer is epoxy, the polymerization initiator may be a hardener; for example a polyfunctional amine, an acid, a phenol, an alcohol, or a thiol.

In step a), the ratio of curable liquid resin monomer or prepolymer to polymerization initiator is defined to reach stoichiometry between curable liquid resin monomer or prepolymer to polymerization initiator. The ratio can so be easily determined by one of ordinary skill in the art, as the ratio is commonly specified on manufacturer datasheet of the products. For example, the ratio may be comprised from 1 to 10. For example, the curable liquid resin monomer or prepolymer and the polymerization initiator may be dosed via a volume or mass flow meter unit.

The mixing of step a) may be carried out by a mean of incorporating a solid phase into a liquid phase. The mean and/or the mixing may avoid incorporating air into the operable curable liquid resin thus obtained. The mean may be selected from the group including an endless screw, and a dispersing machine. In the case the mean is an endless screw, the rotation frequency may be comprised of from 20 Hz to 100 Hz.

The mean temperature of step a) may be chosen so that the reaction can initiate because of a temperature that is sufficiently high, while limiting the speed of the reaction with a temperature that is in the same time sufficiently low, in order to limit the risk of damaging the core of the piece because of a too high temperature. Advantageously, the temperature allows to proceed at the lowest viscosity in order to optimize the insertion of the spheres, to drop the casting pressure and to improve the distribution and filling of the mold during casting: in the same time, the temperature should not be too high in order to prevent runaway polymerization reaction. These systems of operable curable liquid resin monomer or prepolymer and polymerization initiators are known by one of ordinary skill in the art, and he can easily determine this temperature thanks to his common knowledge, and/or thanks to data allowing obtaining an operable curable liquid resin usually provided by the suppliers of resin and polymerization initiators. The mean temperature may be chosen for example of from 15 to 80° C. It may be for example a temperature comprised from 15 to 60° C., or 50° to 80° C. The temperature is depending on the nature of the couple of curable liquid resin monomer or prepolymer and polymerization initiator. As it exists a wide variety of such couples, the mean temperature may be very different from one couple to another. The more accurate temperature for beginning the reaction of step a) is usually provided by the suppliers of resin and polymerization initiators. In one particular embodiment, the temperature may be monitored, during all the duration of step a), in order to be maintained in these ranges of values so that the process of the invention can start and thus limiting and controlling the exothermic peak during step e). Exothermic peak is the temperature likely to be reached during the polymerization of the operable curable resin. This peak is to be limited and controlled during the process of the invention by handling the temperature during one or more, and preferably all, of steps a) to e). The exothermic peak temperature differs depending on the system used, and may be for example comprised of from ambient temperature, i.e. about 25° C., to about 300° C., depending on the nature of the curable liquid resin and the polymerization initiator. The temperature is monitored depending on the kind of curable liquid resin monomer or prepolymer and polymerization initiator. For example, when the operable curable liquid resin monomer or prepolymer is an epoxy resin and the polymerization initiator is an amine hardener, the temperature of step a) may be regulated depending of the system used, for example of from 15° C. to 80° C.

“Control and limit exothermic peak during step e)” means, in the sense of the invention, the capacity of having an exothermic peak during step e), the temperature of which is determined in advance. It also means that the exothermic peak occurs specifically during step e) and not during the previous step a) to d).

The curable liquid resin obtained by implementing step a) is a mixture of the liquid resin monomer or prepolymer and the polymerization initiator, which is in form of a pourable liquid. It may be more particularly an homogenous mixture, almost free of air bubbles, which is in a state, or have a viscosity, at room temperature or at the determined temperature of step b), allowing the mixing defined in step b).

“Low density” means, in the sense of the invention, at least one kind of any element the density of which is less than the density of water. The micro-element may have a density comprised from about 100 to about 700 kg/m³, for example comprised of from 200 to 450 kg/m³, or from 300 to 400 kg/m³. Advantageously, the introduction of the low density elements has the technical function of reducing the weight of the operable curable liquid resin. In other words, for a same volume of operable curable liquid resin, the weight of the operable curable liquid resin alone is higher than the weight of the operable curable liquid resin including the low density elements.

“Micro-element” means, in the sense of the invention, any element that is comprised in a sphere having a diameter comprised from 1 μm to 1 mm. The micro-elements may have the form of a spheroid or an ovoid, for example a sphere. The micro-elements may be made in a material selected from the group including glass, for example Glass micro-sphere 3M™-K20, ceramic, polymer, metal, carbon and fly ash. The micro-element may be hollow, i.e. including air. Alternatively, it may be a solid, i.e. a full, material. It may be nonporous, so it may do not absorb liquid, that may be liquid resin or water. Advantageously, when the low density micro-element is a hollow micro-element, the density of the micro-element is less than the one of a full micro-element. For example, the micro-element may be a hollow glass micro-sphere.

Mixing of step b) may be carried out at a temperature determined in order to obtain a suitable viscosity, i.e. a viscosity allowing mixing, and to control polymerization. Advantageously, the temperature is determined in order to limit and control exothermic peak in step e). The temperature is determined depending on the nature of the operable curable liquid resin, and possibly on the kind of the micro-elements. As it exists a wide variety of resins and of micro-elements, the mean temperature may be very different from one system to another. The more accurate temperature for the reaction of step b) can easily be deduced by one of ordinary skill in the art depending on the nature of the resin. For example, the temperature at the beginning of step b) is usually comprised of from about 15° C. to about 90° C. For example, when the operable curable liquid resin is an epoxy resin and the micro-elements is Glass micro-sphere 3M™-K20, the temperature of step b) may be regulated from 15° C. to 40° C.

The amount of micro-elements may be determined in volume percentage depending on the amount of operable curable liquid resin and of polymerization initiator. The volume ratio of micro-elements/resin may be comprised of from 30% to 75%, preferably about 55%. The amount of micro-elements may be comprised from 10% to 73%, for example 10% to 65%, in volume ratio in the syntactic foam. The micro-elements may, for example, be dosed via a dosimetric pump.

Advantageously, the mixing of step b) is realized in such a manner that the breakage of micro-elements is limited. The mixing of step b) may be carried out by any mean known by one of ordinary skill in the art, for example by a mean selected from the group including an endless screw and a dispersing machine.

The regulated volumetric and/or mass flow rate of step b) is comprised of from 5 to 30 kg/min and/or from 30 to 60 kg/min. Advantageously, the volumetric or mass flow rate is regulated so that all the ratio between micro-elements, resin and polymerization initiator is constant during step b).

The homogenization of step c) may be carried out at a temperature determined in order to obtain a mixture, the viscosity of which allows low shear forces, and/or limits the self-heating of the matrix and then control and/or limit exothermic peak of the reaction. Advantageously, breaking of the micro-element and self-heating of the mixture are avoided, while micro-elements, resin and polymerization initiator are thoroughly mixed. The temperature and the viscosity values are highly dependent of the couple resin/polymerization initiator. However, methods of regulation of the viscosity of such products are commonly known by one of ordinary skill in the art. Furthermore, information about viscosity is usually given, for such products, by the supplier. In this particular embodiment, the temperature is monitored depending on the kind of operable curable liquid resin and the micro-elements.

The mixing of step c) may be carried out by applying a mechanical force on the mixture including or consisting of operable curable liquid resin and micro-elements. The force may be selected from a shear force and a homogenization force resulting in less than about 15% of degradation or breakage of the micro-elements. The mean of applying the mechanical force may be any mean known by one of ordinary skill in the art. It can for example be selected from the group including an endless screw and a powder disperser.

For example, the operable curable liquid resin obtained at the send of step c) may have a dynamic viscosity of from 5 Pa·s to 300 Pa·s, for example of from 50 Pa·s to 200 Pa·s, or for example of from 100 to 150 Pa·s..

The degasing of the mixture including or consisting of operable curable liquid resin and micro-elements may be realized by any method known in the art, for example by applying a vacuum having a value less than the atmospheric pressure. Advantageously, mixing and degasing are realized in line, so the mix is more homogenous with a lower duration process. Advantageously, the in line degasing ensures a syntactic foam with a limited air cavity in the matrix.

The obtained intermediate syntactic foam so contains an operable curable liquid resin and micro-elements, less than 15% being likely to be broken.

“Macro-elements” means, in the sense of the invention, at least one kind of any element that is comprised in a sphere of a diameter comprised from 1 mm to 10 cm. Preferably, the macro-elements have a density lower than the density of water. Advantageously, the macro-elements may improve buoyancy of the syntactic foam. The density of the macro-elements may be comprised of from 100 to 600, for example of from 200 to 500, for example of from 300 to 400. It may be of a shape selected from the group including a spheroid, for example a sphere, an ovoid, a prism, a polyhedron, a cylinder, a cone, a parallelepiped, a cube, a cuboid form, a square-based pyramid, a triangular-based pyramid, and a triangular prism. In a preferred embodiment, the macro-elements may be macro-spheres. The macro-elements may be made in a material selected from the group including thermoplastic, for example polyethylene, polypropylene, polystyrene, and thermosetting plastic, for example Epoxy resin, polyester, or polyurethane, ceramic and steel. In a particular embodiment, the macro-element is made of an outside shell of the sphere in thermoplastic, for example polyethylene, polypropylene or polystyrene, or thermosetting plastic, for example an epoxy resin, a polyester or a polyurethane, or a ceramic or steel, potentially charged with fiber possibly containing glass, carbon and/or mineral. The processes allowing preparing the macro-elements are known by one of ordinary skill in the art. For example, the macro-elements may be made by extrusion blow molding, by additive technology, by assembly of 2 hollow half-element, as for example spheres, for example by welding, gluing or plastic injection. The macro-elements may alternatively be prepared by coating with thermosetting resin a low density center, for example expensed polystyrene. The macro-element may be hollow, or alternatively, it may be a solid, i.e. a full material. Advantageously, when the macro-element is a hollow macro-element. In this embodiment, the density of macro-sphere is reduced compared with a solid macro-element. For example, the macro-element may be a hollow macro-sphere.

The casting of step d) may be carried out at a viscosity determined in order to obtain an homogenous repartition of the intermediate syntactic foam between the macro-elements. The viscosity of step d) may be high enough so that the intermediate syntactic foam flows between the macro-elements. The temperature may be chosen depending on the kind of syntactic foam, and may easily be determined by one of ordinary skill in the art, as the temperature and associated viscosity are commonly specified on manufacturer datasheet of the products. In one particular embodiment, the temperature may also be monitored, during all the duration of step d), in order to be maintained in these ranges of values so as to control and limit exothermic peak during step e). Advantageously, the temperature of step d) is maintained at a temperature that causes no damage to the syntactic foam.

The absence of damage may be checked by implementing casting and polymerization essays, during which the temperature is registered with thermocouples, then the absence of damage on the foam may be verified visually and/or by measuring the temperature of glass transition. For example, when the intermediate syntactic foam is based on epoxy resin the temperature of step d) may be maintained below 140° C.

The amount of macro-elements may be determined depending on the amount of intermediate syntactic foam. For example, the amount of the macro-elements may be comprised of from 10 to 99% compared to the total volume of the piece within the container. For example, when macro-elements are macrospheres, their amount may be comprised of from 43% to 64%, notably when macro-spheres are of identical diameter.

The volume of intermediate syntactic foam casted into a container may be greater than 1 liter. It may be for example greater than 2 liters, for example it can be of 3 or 4 liters. In the case where the casting is made according to a batch process, the volume casted into the container may be unlimited.

The casting of step d) may be realized in several successive castings.

Step e) of hardening the operable curable liquid resin, which is contained in the intermediate syntactic foam, may be realized by any method allowing providing energy to the system, then hardening of the operable curable liquid resin. It can be for example by use of micro-wave, heating, UV, catalyst. During the hardening of the operable curable liquid resin, the temperature may be maintained under a temperature so that the system not be degraded. This temperature depends on the kind of syntactic foam and/or of micro-elements and/or of macro-elements. It can be easily determined by one of ordinary skill in the art. Advantageously, step e) of hardening the operable curable liquid resin may be realized at a temperature that causes no damage to the macro-elements. Advantageously, the temperature of step d) is maintained at a temperature that causes no damage to the syntactic foam. The absence of damage may be checked by implementing casting and polymerization essays, during which the temperature is registered with thermocouples, then the absence of damage on the surface of the foam may be verified visually and/or by measuring the temperature of glass transition. Alternatively or in a complementary manner, the temperature of glass transition may be measured. For example, this temperature may be maintained under 100° C. when the macro-elements are in polyethylene. In one particular embodiment, the temperature may also be monitored, during all the duration of step e), in order to check that the temperature stays under the breaking-down temperature of the syntactic foam.

The temperature may be regulated, in one or more of step(s) a) to e) to limit and control exothermic peak during step e) as mentioned above, by any method known by one of ordinary skill in the art. The method may use, for example, a vessel of intermediate heat transfer or a temperature exchanger in line.

The container may be any container able to receive the syntactic foam and to resist to hardening of the operable curable liquid resin. The container may be closed after hardening of the operable curable liquid resin. The container may be non-waterproof or waterproof. It may be, for example, a rotational molding in Linear low-density polyethylene or in Medium-density polyethylene, or a mould in metal, for example steel or aluminium or a composite material. In another embodiment, the container may be removed after step e) of the process.

Steps a) to e) may be carried out in a batch or in a continuous flow process. In one embodiment, some of steps a) to e) may be carried out in a batch and the other steps may be carried out in a continuous flow process. Advantageously, in case of a continuous casting, the process of the invention is able to cast large parts, for example up to about 7 m³, or higher, and/or small parts compared the classical casting process per batch, depending on the reactor size chosen by the user.

The obtained syntactic foam may have a density of from 200 kg/m³ to 800 kg/m³. It can be for example a density of from 300 kg/m³ to 700 kg/m³′ or of from 400 kg/m³ to 600 kg/m³, or of from 450 kg/m³ to 550 kg/m³.

In the case microelements are microshperes, and macroelements are macrospheres, the buoyancy of the syntactic foam may be defined according the principle (I):

Buoyancy=V_{Shell}×(ρ_{fluid}−ρ_{COMPOSITE SYNTACTIC FOAM}) (I)

### With:

Buoyancy: defined as ascendant vertical force that a fluid exerts on the syntactic Foam in Kg.
V_{Shell}: defined as the internal volume of the container in m³
ρ_{fluid}: defined as the density of fluid in that the Composite syntactic foam is immerged in kg/m³
ρ_{COMPOSITE SYNTACTIC FOAM}: defined as the density in kg/m³ of the Composite syntactic foam in kg/m³

Wherein

ρ_{COMPOSITE SYNTACTIC FOAM}=%_{Volume Macrosphere}×ρ_{Macrosphere}+%_{Volume Experimental syntactic foam}×ρ_{Experimental syntactic foam}

with:

%_{Volume Macrosphere}: defined as the real volume taken by the macrosphere inside the shell

ρ_{Macrosphere}: defined as the real density of the macrosphere in kg/m³

%_{Volume Experimental syntactic foam}: defined as the volume of the syntactic foam inside the shell in m³

ρ_{Experimental syntactic foam}: defined as the real density of the syntactic foam after process, taking into account air in the matrix and the ratio of broken microsphere in kg/m³

ρ_{Experimental syntactic foam}=Y_{Process}×(%_{Volume Hardener}×ρ_{Hardener}+%_{Volume μsphere}×ρ_{μsphere}+%_{Volume Resin}×ρ_{Resin})

With:

%_{Volume Hardener}: defined as the calculated ratio of hardener in order to have the correct stoichiometry with the resin in %
ρ_{Hardener}: defined as the density of the Hardener in kg/m³
%_{Volume μsphere}: defined as the calculated ratio of microsphere defined for the syntactic foam recipe in %
ρ_{μsphere}: defined as the density of microsphere in kg/m³%
%_{Volume Resin}: defined as the calculated ratio of resin in order to have the correct stoichiometry with the hardener in %
ρ_{Resin}: defined as the density of the resin in kg/m³

γ_{Process} is the factor taking into account: process loss, remaining void in the matrix, shrinkage during polymerization, microsphere breakage ratio. This factor is different for each matrix and microspheres used.

$${\%}_{Volume Macrosphere} Calculation \text{:} {\%}_{Volume Macrosphere} = 1 - {\%}_{porosity} {\%}_{Volume Msphere} = \frac{{V}_{wall affected}}{{V}_{shell}} \times ( 1 - {\%}_{porosity affected by the wall} ) + \frac{{V}_{closed packed}}{{V}_{shell}} \times ( 1 - {\%}_{porosity close packed} )$$

$${\%}_{Volume Macrosphere} = \frac{{V}_{wall affected}}{{V}_{shell}} \times ( 1 - {\%}_{porosity affected by the wall} ) + \frac{{V}_{closed packed}}{{V}_{shell}} \times ( 1 - {\%}_{porosity close packed} )$$

%_{porosity affected the wall}: defined as the available space between sphere in contact with the shell, this is an experimental value, as defined in Ben Aïm and Le Goff, “Effet de paroi dans les empilements désordonnés de sphères et application à la parasité de mélanges binaires”, Powder Technol, 1 (1967/68) 281-290 ([2]).
%_{porosity close packed}: defined as the available space between sphere when the shell is no more affecting macrosphere packing, this is an experimental value, as defined in Ben Kim and Le Goff ([2]).

V_{wall affected} defined as the volume occupied by all halves macrospheres in contact with the shell. This measure shall be determined using CAD software. For simple shape volume V_{wall affected} of fact-ad can be calculated analytically.

V_{wall affected} may be in m³.

V_{closed packed}=Vₛₑₗₗ−V_{wall affected}

V_{closed packed} may be in m³.

Some embodiments relate to a process for manufacturing a buoyancy material including an outer shell and a syntactic foam, said manufacturing process comprising the steps of:
a) Mixing together a determined amount of a curable liquid resin monomer or prepolymer and a polymerization initiator in order to obtain an operable curable liquid resin;
b) Mixing at a determined temperature range the operable curable liquid resin with a determined amount of at least one type of low density micro-elements, said micro-elements being comprised in a sphere having a diameter comprised from 1 μm to 1 mm and being introduced continuously in the operable curable liquid resin and at a constant volumetric and/or mass flow rate, while limiting breakage of micro-elements;
c) Homogenizing at a determined temperature range and degasing the mixture of operable curable liquid resin and micro-elements in order to obtain an intermediate syntactic foam;
d) Casting at a determined temperature range the intermediate syntactic foam in a container optionally including a determined amount of macro-elements being comprised in a sphere of a diameter comprised from 1 mm to 10 cm; and
e) Hardening the operable curable liquid resin;
   wherein the temperature is regulated, in one or more of step(s) a) to e), to avoid exothermic peak during steps a) to e),
   wherein the container determines the outer shell of the buoyancy, thereby obtaining the buoyancy material.

The outer shell may be the container that also helps to receive the intermediate syntactic foam and the syntactic foam in step d) of the process of the invention, and that is already defined above.

Alternatively, the container may be removed. In this embodiment, the outer shell is the outer surface of the hardened resin obtained in step e).

In a different embodiment, the container may be removed and replaced by a coating that is the outer shell. In the case, the outer shell may be in a fabric selected among glass fibre, painting, tissue, polymer such as Linear low-density polyethylene and Medium-density polyethylene, polyurethane coating.

The process for manufacturing a buoyancy material includes the steps of the process for making a syntactic foam. In other words, steps a) to e) of the process for making a syntactic foam are the same as steps a) to e) of the process for manufacturing a buoyancy material. All the definitions and embodiments of the process for making a syntactic foam are applicable to the process for manufacturing a buoyancy material.

The buoyancy material of the invention may be manufactured to float at a distance from the surface of the sea of 200 m.

The buoyancy material may be manufactured to float at a distance from the surface of the sea of 600 m.

The buoyancy material may be manufactured to float at a distance from the surface of the sea of 4000 m.

Advantageously, the buoyancy may be calculated for a module, based on the density of the syntactic foam, according to Formula (II):

Buoyancy_{mod-CSF}=Vₛₕₑₗₗ×(ρ_{COMPOSITE SYNTACTIC FOAM}−ρ_{sea water}) (II)

Buoyancy_{mod-CSF}: defined as the buoyancy of the composite syntactic foam without taking into account the shell and components accessories in kg

ρ_{COMPOSITE SYNTACTIC FOAM}: defined as the density of the Composite Syntactic Foam in kg/m3

Advantageously, the module assembly buoyancy calculation may be calculated according to Formula (III):

Buoyancy_{mod}=Buoyancy_{mod-CSF}+Weight in sea water_{Components} (III)

Weight in sea water_{Components} is defined as the Weight of each components accessories in sea water (as metal inserts, clamp, tensioning system . . . ), for non buoyant material; the weight in sea water shall be subtracted to the composite syntactic foam buoyancy for buoyant material, and the weight shall be added to the composite syntactic foam buoyancy in kg.

Buoyancy_{mod} is defined as module (shell and components) buoyancy in kg.

Some embodiments relate to a syntactic foam obtainable by the process of the invention, including macro-elements dispersed in a mixture of a matrix including a curable liquid resin and low density microelements, in which said macro-elements are comprised in a sphere of a diameter comprised from 1 mm to 10 cm and said micro-elements being comprised in a sphere having a diameter comprised from 1 μm to 1 mm. In one embodiment, the curable liquid resin is an epoxy resin, the micro-elements are hollow glass micro-elements and the macro-elements are hollow macro-elements.

Some embodiments relate to a buoyancy material including a syntactic foam obtainable by the process of the invention.

Some embodiments relate to a buoyancy material obtainable by carrying out the process of the invention.

Some embodiments relate to a process of undersea extraction of oil including the step of using a syntactic foam of the invention or a buoyancy material of the invention.

The syntactic or buoyancy material may maintain at a defined undersea level a undersea extracting pipeline.

Advantageously, the undersea extracting pipeline includes a pipeline and either a syntactic foam of the invention or a buoyancy material of the invention.

Other advantages may also become apparent to a one of ordinary skill in the art on reading the examples given below, illustrated by the appended figures, given for purposes of illustration.

### BRIEF DESCRIPTION OF THE FIGURES

FIG. 1 shows demonstration of a Distributed Buoyancy Module used in order to lighten a flexible pipe, the diameter of which is 338 mm, including a water injection riser, and having a shell (container) thickness of 10 mm, and a syntactic foam volume in the half shell of 1.56 m³.

FIG. 2 shows demonstration of a Modular Installation Buoyancy in order to lighten an equipment during installation steps.

FIG. 3 shows Buoyancy Principle, with Buoyancy, m_{object}, ρ_{fluid} and ρ_{object}.

FIG. 4 shows the syntactic foam with water absorption (arrows), with Polymer Matrix (1) and Micro Glass Bubbles and/or Macro Spheres (2).

FIG. 5 shows with a (A): Buoyancy module internal view; A Buoyancy Module has been cut in order to control the core of the syntactic foam of the invention; a Buoyancy Module Shell (3) consisting of 8 mm low Linear Density Polyethylene and a Composite Syntactic Foam of the invention (4). (B-Scale: 1 cm=2.5 cm): Syntactic Foam of the invention composed for example by Epoxy Matrix and Hollow Glass Microspheres (5) and Hollow Polymer Macro Sphere (6). (C): Hollow Glass Microspheres in the matrix.

FIG. 6 shows Glass micro-spheres before blended in the matrix.

FIG. 7 shows Glass micro-spheres microscope view.

FIG. 8 shows Thermoplastic Macrosphere.

FIG. 9 shows Buoyancy measurement procedure.

FIG. 10 shows the three steps for the determination of buoyancy, as a function of net buoyancy during the design period between the buoyancy at service pressure and the buoyancy at the end of service life, with the buoyancy targeted after manufacturing, the net buoyancy at start of design period, and the net buoyancy at end of service life.

FIG. 11 shows the effect of the shell wall on the porosity between spheres. (A): effect of the wall on packing. (B): porosity in function of the distance to the wall expressed in sphere diameter.

FIG. 12 shows (A) an Example of the effect of the shell wall on the porosity with a cube, detail Closed Packed Volume/Volume Affected by the wall of the shell. (7) is the volume Total of the Shell (in grey): Vₛₕₑₗₗ. (8) is the distance between the wall of the shell and the volume closed packed 0.5×Macrosphere Diameter. (9) is the volume inside the shell affected by the wall: V_{wall affected}. (10) is the volume closed packed (in red): V_{closed packed}. (B) shows a buoyancy module shape, having an external diameter (a), an internal diameter (b) and a height (c).

FIG. 13 shows the syntactic foam casting machine principle, containing: an output (11), a Head Mixing and a Unit Mix Microsphere with Matrix (12), a vacuum unit that removes Air bubble in the Mix (13), a Pre-Mix binder and a Mix 2 Epoxy components (14), Fillers Hopper Receiving fillers from the top (15), a Microsphere Metering Hopper (16), a Hardener Intermediate Tank regulate in temperature (17), a Mass Flow Meter Regulate in line the mass flow of each matrix component temperature (18), a resin intermediate tank regulate in temperature (19).

FIG. 14 shows the process for buoyancy module product (part 1 to 6).

### EXAMPLES

### Example 1: Material Description

1.1 Product Example: Distributed Buoyancy Module

The syntactic foam of the invention is casted inside a shell or a mold, the volume casted may be contained between 30 liters to 3-4 m³ per parts.

Distributed buoyancy modules generally consist of an internal clamping system and syntactic foam buoyancy elements. The buoyancy elements may be supplied in two halves incorporating a molded internal recess that is configured to transfer the forces from the buoyancy to the clamp and subsequently the riser.

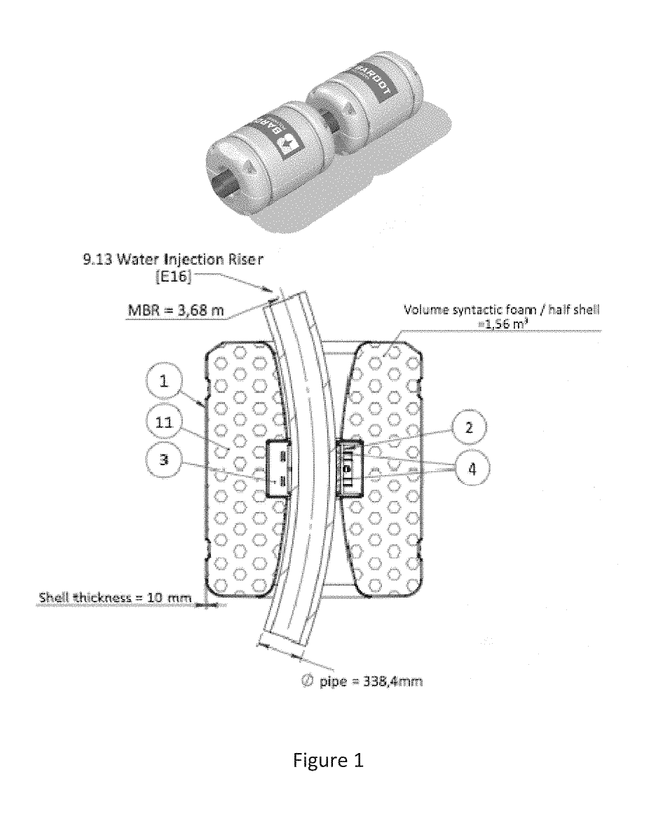

This recess also accommodates bending of the riser during service. The internal clamping system may be fixed to the pipe and the two half modules may be fastened around the clamp. See FIG. 1.

1.2 Product Example: Installation Modular Buoyancy

The installation modular buoyancy mostly used during installation phases. With this kind of buoyancy, the goal is to reduce handling needs and facilitate the installation of heavy material.

In the water, equipment with high weight coupled to modular buoyancy, the apparent weight of the 2 equipment can be null.

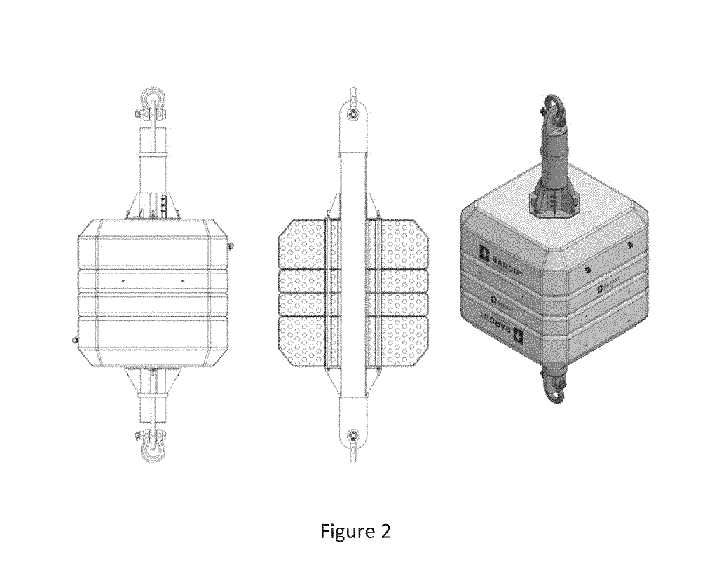

See FIG. 2.

1.3 Physical Principle

The Syntactic foam shall provide buoyancy, at determined depth under water, without loose performance over years. These 3 physicals principles are explained in the next 3 chapters.

1.3.1 Buoyancy

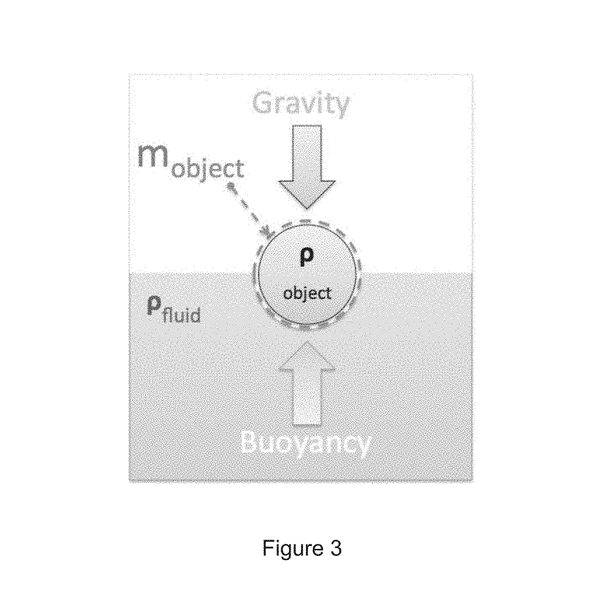

Any object, wholly or partially immersed in a fluid, is buoyed up by a force equal to the weight of the fluid displaced by the object.
Archimedes of Syracuse. See FIG. 3, providing the buoyancy principle, in which:

Buoyancy=Vertical ascending Force pushing the submerged object to the surface

m_{object}=In this case the mass of the syntactic foam in air
ρ_{fluid}=In this case ρ_{sea water}
ρ_{object}=In this case ρ_{syntactic foam}
In our case object is wholly immersed in the fluid:

V_{sea water displaced}=V_{syntactic foam}=V

Buoyancy=m_{syntactic foam}−m_{sea water displaced}

Buoyancy=V×ρ_{syntactic foam}−V×ρ_{sea water}

Buoyancy=V×(ρ_{syntactic foam}−ρ_{sea water})

Where:

m in kg

V in m³

ρ in Kg/m³

Buoyancy in kg

1.3.2 Hydrostatic Pressure

The pressure exerted by a fluid at equilibrium at a given point within the fluid, due to the force of gravity. Hydrostatic pressure increases in proportion to depth measured from the surface because of the increasing weight of fluid exerting downward force from above.

Hydrostatic pressure in a liquid can determined using the following equation:

p_{hydro}=h×p×g

where

p=pressure (N/m², Pa)

h=height of fluid column, or depth in the fluid at which the pressure is measured (m)

ρ=density of liquid (kg/m³)

g=the gravitational constant (9.81 m/s²)

Simplifying, a quick way to determine the hydrostatic pressure function the depth in the seawater is to approximate that each 10 m deeper in sea water the pressure increase 1 bar.

100 SWM→10 bars

1000 SWM→100 Bars

1.3.3 Water Absorption

The water absorption is the capacity of the material to absorb water in wet condition. In the case of Syntactic Foam in subsea condition, the water absorption can be limited (less than 5% on 25 years) and controlled.

The syntactic foam is particularly adapted for this condition. All void created in the foam is encapsulated in a closed cell sphere. These spheres are infused in a polymer matrix.

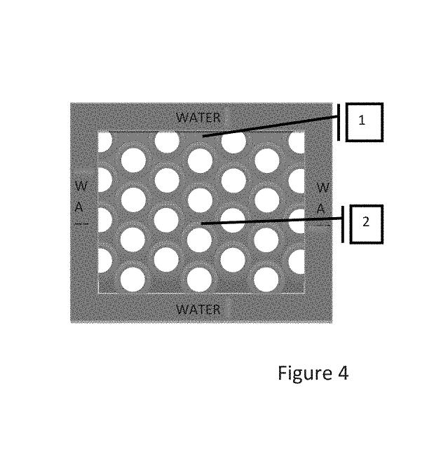

All material used are specifically developed in order to have a very stable behaviour over the service life. See FIG. 4.

The use of micro-elements as Micro Glass Bubbles and macro-elements as macro sphere in a curable liquid resin as Epoxy Matrix does not allow the water to ingress inside the foam and ensures the foam performance during the service life.

1.4 Principle of the Syntactic Foam of the Invention

The syntactic foam of the invention is a Composite Syntactic Foam.

Generally speaking, a syntactic foam is a composite closed cell foam. Cells are created by blending micro hollow spheres inside a polymer matrix.

In the syntactic foam of the invention are added macro elements, for example hollow marco-elements, in order to reduce the density.

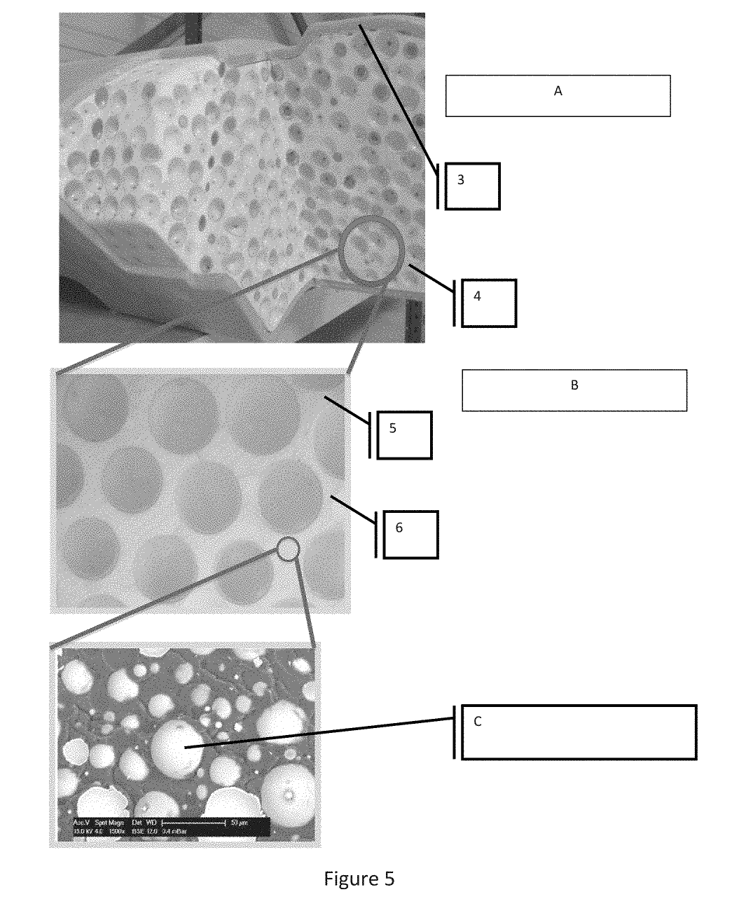

See FIG. 5.

### Example 2: Composition of the Composite Syntactic Foam of the Invention

1. Micro-Elements

Micro-elements may be selected from the group including: glass, ceramic, polymer, metal and carbon.

In one embodiment, micro-elements are hollow glass microspheres.

Glass Bubbles are engineered hollow glass microspheres that are low-density particles.

There are used in the matrix to:
Reduce foam density→Range density start from 125 kg/m³ to 600 kg/m³
lower costs
enhance product properties

The spherical shape of glass bubbles offers a number of important benefits, including:
higher filler loading
reduced shrinkage and warpage
high hydrostatic pressure strength.

The chemically stable soda-lime-borosilicate glass composition of glass bubbles provides excellent water resistance. They are also non-combustible and non-porous, so they do not absorb resin. And, their low alkalinity gives glass bubbles compatibility with most resins, stable viscosity and long shelf life.

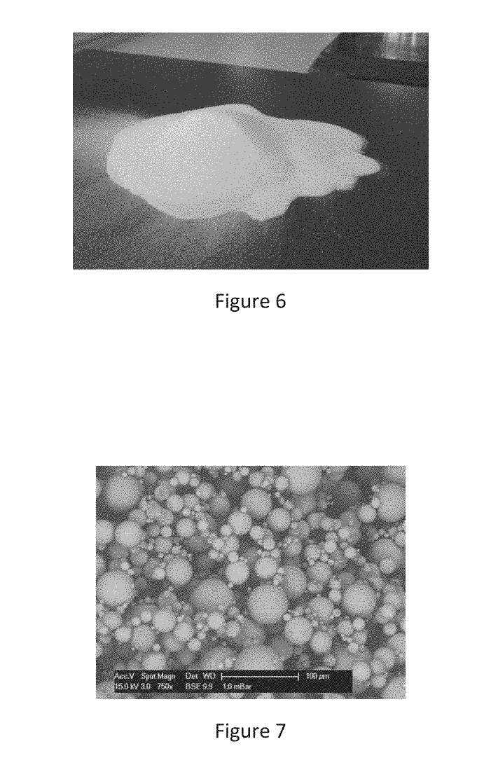

See FIGS. 6 and 7.

2. Macrospheres

Macro-elements may be in a material selected from the group including a thermosetting resin such as an epoxy resin or a polyester resin, or a thermoplastic resin such as polyethylene, or a ceramic and steel.

In one embodiment, with the aim to reduce the density and the quantity of matrix (denser than water), Hollow Macrospheres are added.

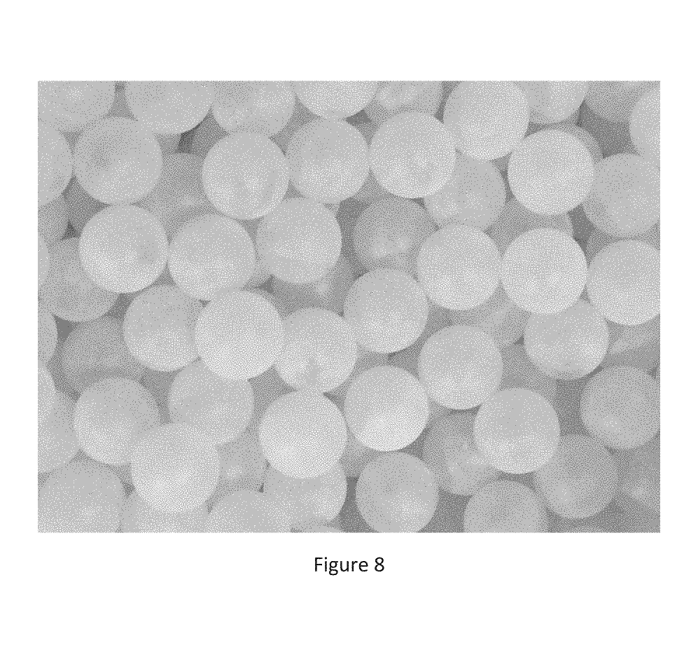

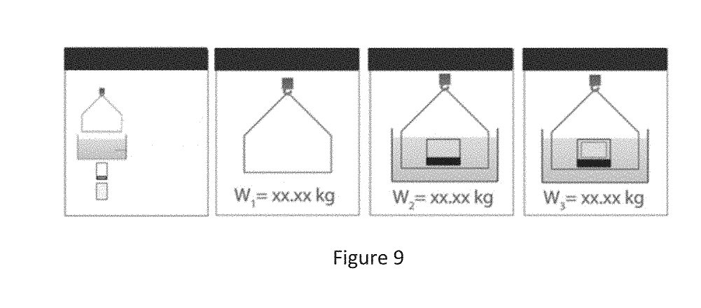

Technology Macrospheres technologies are used: See FIGS. 8 and 9.

Thermoplastic Macropsheres: Hemispheres may be injected and 2 hemispheres may be welded by hot plate process.

3. Curable Liquid Resin

The curable liquid resin monomer or prepolymer is an Epoxy Matrix.

The resin may be for example a Epoxy Bisphenol A diglycidyl ether based.

The polymerization initiator may be a amine hardener.

At ambient temperature, Epoxy Resin may be transparent and has a viscosity similar to hot honey. The Epoxy Resin has a viscosity at 15° C. of from 5200 to 9200 mPa·s. It may have a viscosity at 40° C. of from 300 to 550 mPa·s. Its density may be, at 20° C., of from 1 to 1.5. The hardening of the Epoxy Resin may occur to room temperature, and the post-curring from 40-80° C.

The polymerization initiator is transparent yellow, with a viscosity similar to water. Its viscosity may be comprised, at 15° C., from 25 to 45 mPa·s. At 40° C., the hardener may have a viscosity of from 8 to 15 mPa·s. Its density may be, at 20° C., of from 0.90 to 1.10.

The mixing ratio per weight Epoxy Resin/Hardener is comprised of from 50/50 to 100/60.

The mixture of Hardener and Epoxy Resin may have a viscosity, at 20° C., of from 300 to 530 mPa·s, for example of from 355 to 505, for example about 420 mPa·s. At 50° C., the viscosity may be of from 30 to 70 mPa·s.

The exothermic peak of the mixture may reach, for example, for a temperature of the mixture regulated to a maximum of 40° C., 140° C. For a temperature of the mixture regulated to a maximum of 30° C., the exothermic peak may reach 55° C. And for a temperature regulated to a maximum of 20° C., there is no exothermic peak.

### Example 3: Syntactic Foam Testing

The main 3 factors to control in order to produce a Foam compliant with requirement are:
The foam Density
The Volume casted
The foam hydrostatic performance (short and long term)

For the composite syntactic foam, full characterization testing reports are provided to certify the performance of the material versus the application.

For each Composite Syntactic Foam recipes of the invention, following test are performed:

1. Density Control

The aim of this test is to control that the syntactic foam produced is in accordance with specifications.

If the density controlled is not in accordance with specifications, the final buoyancy of the product will be wrong and the syntactic foam will not have right performance.

The density of each component is controlled then the density of syntactic foam manufactured is controlled.

Density may be controlled using any test available to one of ordinary skill in the art.

2. Epoxy Glass Transition Temperature

The aim of this test is to control that the matrix will have right reticulation level. Glass transition temperature shall be in accordance with syntactic foam specification. If the Glass transition is not in accordance with specification the matrix will not have chemical and mechanical performance and the final product will underperform.

Reticulation level of the matrix may be controlled using any test available to one of ordinary skill in the art.

3. Hydrostatic Strength and Water Absorption Test Instrumented Buoyancy Loss Test.

Before, during and/or after production, samples of the syntactic foam of the invention are casted in order to control full system performance.

The aim of this test is to immerse a representative sample and rise up the pressure up to service pressure rated for the recipe. The size sample is: 300 mm diameter and 800 mm length.

The buoyancy of the sample is registered during the full test.

After the test is calculated the Buoyancy loss over the service life of the product.

The duration of the test is as per specification; common values are 96 hours test first part validation test and 24 h test spread on the production.

Any test procedure available to one of ordinary skill in the art may be used in order to measure the hydrostatic performance of the buoyancy. It may be for example a test as described in the documents

4. Effective Buoyancy

A buoyancy test is carried out in order to control that the buoyancy module uplift complies with requirement.

In this case the full-scale buoyancy module is immerged in water in order to verify if the buoyancy measured are in accordance with the buoyancy required.

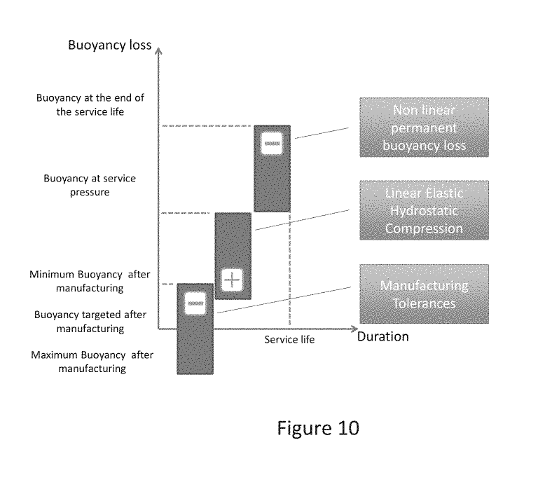

Any test procedure available to one of ordinary skill in the art may be used in order to control that the buoyancy module uplift complies with requirement. The general principle is described in FIG. 10.

### Example 4: Syntactic Foam Performance

Throughout their design life, the buoyancy modules may be submerged at the design water depth stated in project requirements. These conditions require a syntactic foam suitable for operations at the depth specified.

During this time, the syntactic foam may have a limited and controlled buoyancy loss due to initial hydrostatic compression, water absorption and hydrostatic creep.

Therefore, there may be three steps for the determination of buoyancy to meet with requirements:
Buoyancy targeted after manufacturing
The net buoyancy at the maximum operating depth
The net buoyancy at end of service life,

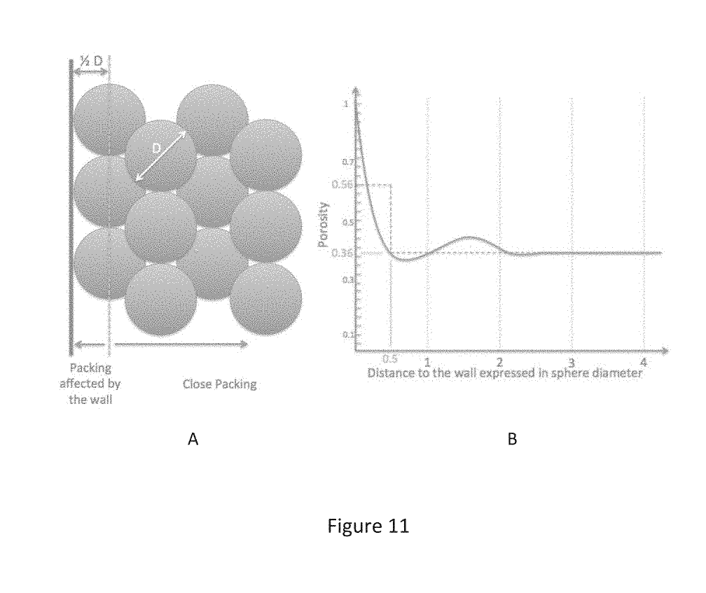

### See FIG. 11.

The aim of the buoyancy analysis is to ensure that the net buoyancy required is always maintained during the design period between the Buoyancy at service pressure and Buoyancy at the end of the service life

The buoyancy under hydrostatic pressure, is a short term buoyancy. In this case the buoyancy variation (gain or loss) is reversible. If the pressure is removed the value back to the buoyancy targeted after manufacturing. It is thus defined knowing:
The buoyancy targeted after manufacturing, (gain or loss)
The Linear Elastic Hydrostatic Compression due to the sea water pressure (gain or loss)

The minimum long term buoyancy is the buoyancy under hydrostatic pressure after the design period. It is thus defined knowing:
The buoyancy targeted after manufacturing, taking into account the minimum
The Linear Elastic Hydrostatic Compression due to the sea water pressure, taking into account the minimum
The Buoyancy at the end of the service life due to the non linear permanent buoyancy loss, taking into account the minimum.

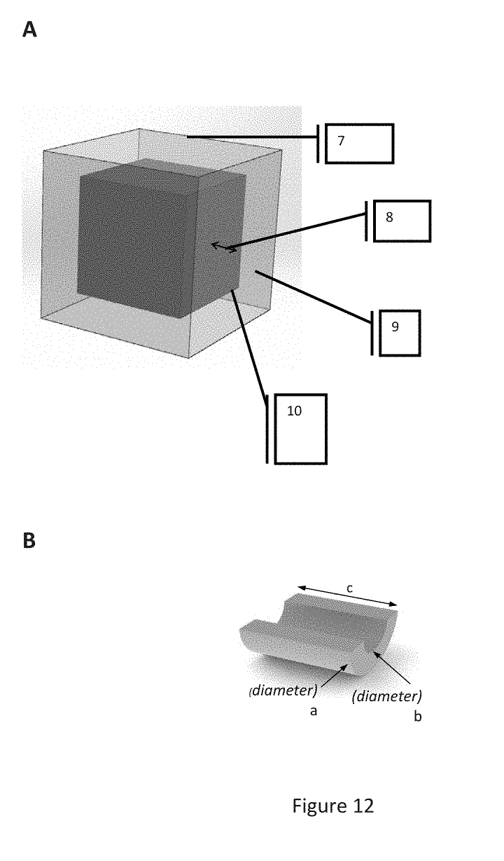

This is illustrated on the FIG. 12.

The contribution of all the buoyancy loss factors may be taken into account on:

Buoyancy at the end of the service life=Buoyancy after manufacturing+Linear Hydrostatic Buoyancy variation+Non linear permanent buoyancy loss

Density Recipes Calculation

$$Buoyancy = {V}_{Shell} \times ( {ρ}_{fluid} - {ρ}_{SYNTACTIC FOAM} )$$

$${ρ}_{SYNTACTIC FOAM} = {\%}_{Volume Macrosphere} \times {ρ}_{Macrosphere} + {γ}_{Process} \times ( {\%}_{Volume μ sphere} \times {ρ}_{μ sphere} + {\%}_{Volume Epoxy} \times {ρ}_{Epoxy} )$$

γ_{Process} factor taking into account, process loss, remaining void in the matrix, shrinkage during polymerization, microsphere breakage ratio. This factor is different for each matrix and microspheres used.

ρ_{Epoxy}=ρ_{Hardener}×%_{Volume Hardener}+ρ_{Resin}×ρ_{Volume Resin}

%_{Volume Macrosphere} Calulation:

The amount of spheres in a shell is related to the wall effect of the shell receiving spheres.

Smaller is the sphere regarding the total volume of the shell more the packing will be optimized.

The goal is to saturate the inside volume of the shell by macrosphere, taking care the packing, the volume of macrosphere may be inferior to 100%, for example from 50 to 70%.

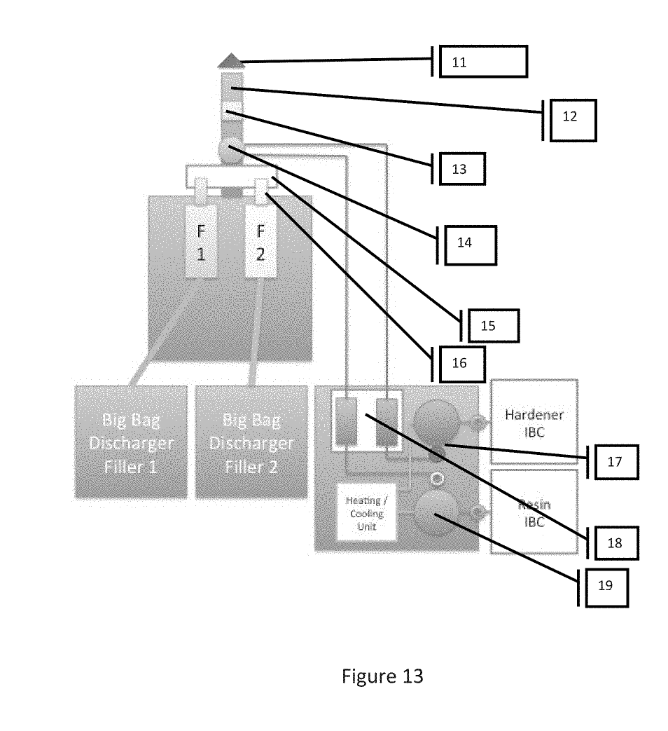

In the FIG. 13 is showed the effect of the wall on packing, the porosity is the space between sphere:

%_{Volume Macrosphere}=1%_{porosity}

As demonstrated in the FIG. 13, at 0.5× the diameter of the sphere the average porosity become stable to reach %_{porosity close packed}=36%.

From the wall of the shell to 0.5 the diameter of the sphere the average porosity is %_{porosity affected by the wall}=56%.

Then the formula to determinate the average packing in the shell is:

%_{Volume Msphere}=V_{wall affected}×(1−%_{porosity affected by the wall})+V_{closed packed}×(1−%_{porosity close packed})

V_{wall affected} is the volume occupied by all halves marcospheres in contact with the shell. This measure may be determined using CAD software (available at CMS IntelliCAD). For simple shape volume V_{wall affected} can be calculated analytically.

V_{wall affected} in m³

V_{closed packed}=Vₛₕₑₗₗ−V_{wall affected}

V_{closed packed} in m³

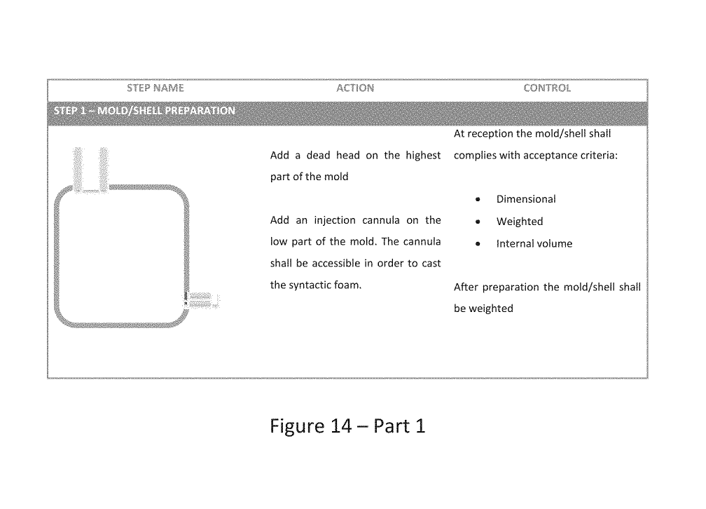

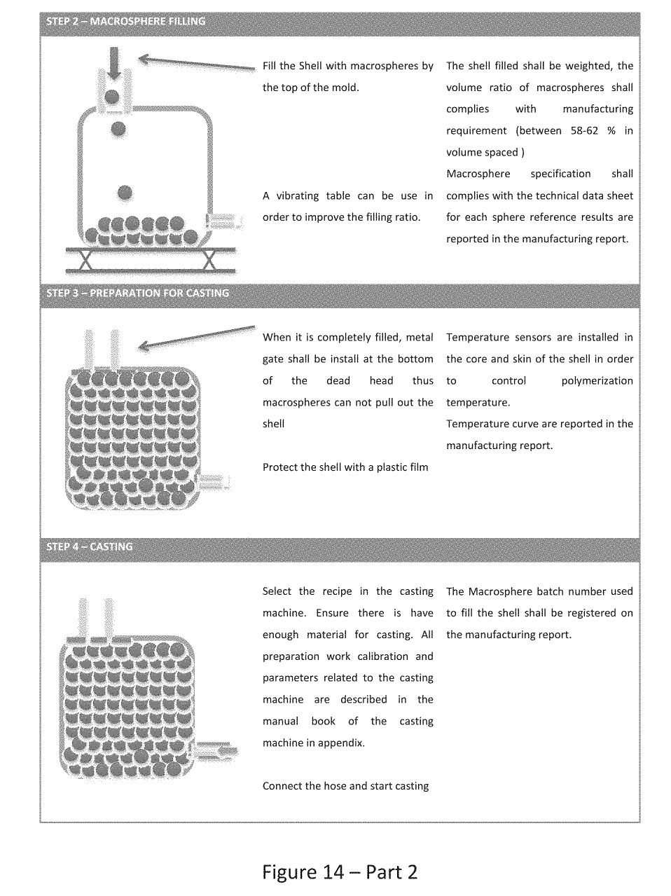

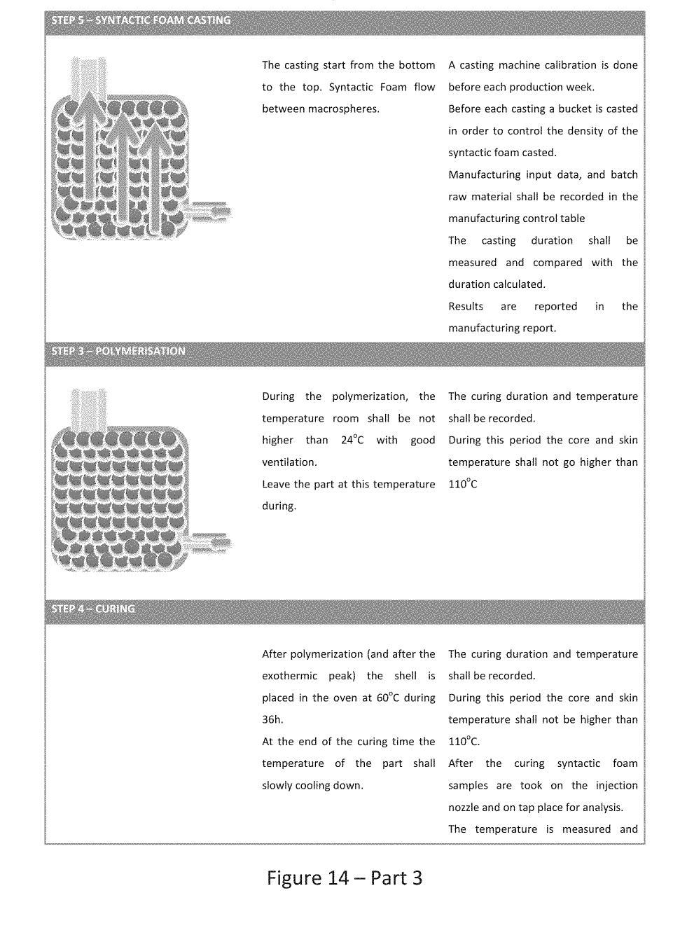

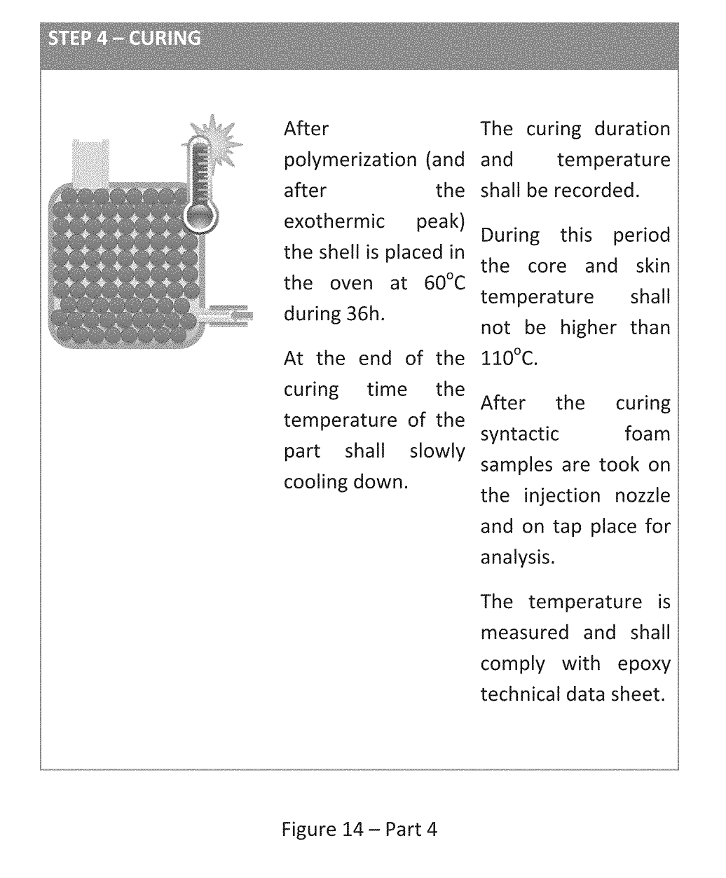

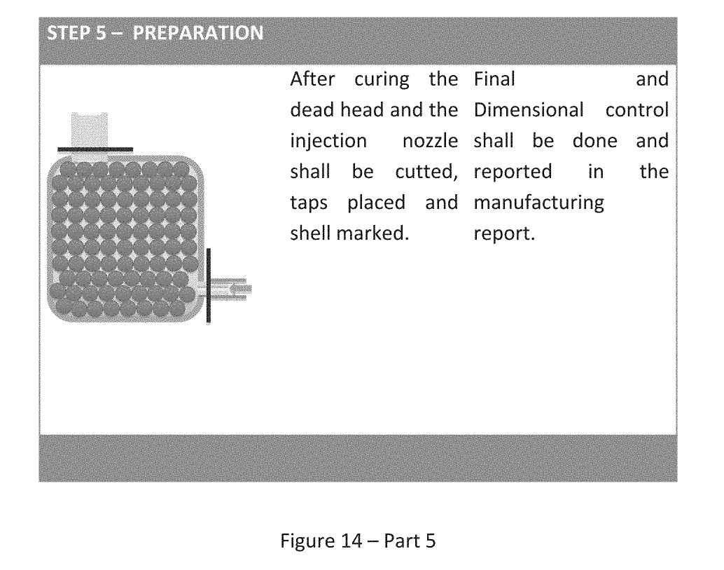

See FIG. 14.

### Example 5: Example of Manufacturing Process

This chapter aim to describe the Manufacturing process in order to produce composite syntactic foam of the invention.

1. Handling of Raw Material

In addition to ensuring good standards of industrial hygiene, as well as applying the measures given in the material safety data sheets (MSDS), it is recommended to follow the procedures indicated below in order to avoid contamination of the formulations.

The resins (components A and B) are available in 2001 steel drums or 1 cubic meter intermediate bulk containers (IBC).

Each Component is sensitive to water and to oxygen, resulting in a change of material proprieties after polymerization. Containers may be open just before use and the cap with water absorber system may replace the original cap.

Intermediary tank and feed lines destined to be filled with resin may be clean.

Container may be placed on retention tank.

Microspheres may be available in 1 or 2 cubic meter big-bag. Moisture stick microspheres together in order to avoid this effect big-bag may stay closed until installation and use.

Macrospheres are available in 1 cubic meter big-bag. Big-bag shall be carefully handled spheres shall not receive strokes or impact and thus weakening balls. Big-bag shall stay closed in order to avoid dust on spheres.

2. Material Storage

For Epoxy 2 Components:

The recommended storage range is from 5° C. to 50° C.

Under these storage conditions, 24 months shelf life of the product is guaranteed from the date of delivery in the original sealed packing.

For Microspheres:

To help ensure ease of storage and handling while maintaining free flowing properties, Glass Bubbles have been made from a chemically stable glass and are packaged in a heavy duty polyethylene bag within a cardboard container.

Minimum storage conditions should be unopened bags in an unheated warehouse.

Under high humidity conditions with the ambient temperature cycling over a wide range, moisture can be drawn into the bag as the temperature drops and the air contracts. The result may be moisture condensation within the bag. Extended exposure to these conditions may result in “caking” of the glass bubbles to various degrees. To minimize the potential for “caking” and prolong the storage life, the following suggestions are made:
Carefully re-tie open bags after use.
If the polyethylene bag is punctured during shipping or handling, use this bag as soon as possible, patch the hole, or insert the contents into an undamaged bag.

During hot and humid months, store in the driest, coolest space available.

If controlled storage conditions are unavailable, carry a minimum inventory, and process on a first in/first out basis.

For Macrospheres:

Macrospheres shall be stored in a dry and free dust area.

Storage temperature shall not be higher than 70° C.

### Example 6: Syntactic Foam Casting Machine Principle

To process the syntactic foam material, a casting machine is used, for high quality manufacturing and productivity.

An automatic in line component regulation is used in order to ensure the right mix proportion and the stability of the mix during the casting.

All parameters are controlled and monitored by the machine and allow to know exactly the properties of the material which is casted:
The casting machine regulates temperature and mass flow rate of each matrix components of matrix.
The special in line degassing remove air bubble from the mix See FIG. 15.

Before casting:
Intermediate tank are automatically pumped from polymerization initiator and Resin IBC Components are tempered (heated or cooled) in order to reach 24° C.
Metering hopper (F1 and F2) are automatically filled by Fumed silica and micro spheres
   During the casting:
Epoxy and polymerization initiator are pumped from the intermediates tanks to the pre-mix binder, the mass flow of each component are regulated using Mass flow meters.
The polymerization initiator and the Resin are mixed in the Pre-Mix binder
At the same time Fillers are distributed at constantan flow with metering hopper and are transferred in the Fillers Hooper.
Then liquids and Fillers are mixed together with an endless screw (This mixing technique not break microspheres)
The vacuum unit remove bubbles from the mix
Finally the Syntactic foam go out mixing head through the output and can be poured in the mould filled with Macrospheres.
   After the casting:
The mixing head shall be clean with the automatic cleaning process.

### Example 7: Manufacturing Process

The purpose of the section is to explain the manufacturing process in order to produce Composite Syntactic Foam of the invention.

The process consists in mixing each component:
Compiling with stoichiometry
Following temperature and duration for each step
Without altering the mechanical characteristics of hollow spheres
Without including air in the mix

Composite syntactic foam Manufacturing Steps are described in FIG. 16.

1. Step of Mixing the Curable Liquid Resin Monomer or Prepolymer with the Polymerization Initiator

The beginning of the mixing may be realized at the minimum temperature necessary for initializing the polymerization while controlling and limiting exothermic peak during one or more of step(s) a) to e). This minimum temperature may be comprised from 15° C. to 90° C., depending on the nature of the curable liquid resin and of the polymerization initiator.

During the mixing of the curable liquid resin monomer or prepolymer and the polymerization initiator, the temperature should not exceed 90-120° C., and should be handled under 90-120° C. During Polymerization, epoxies have exothermic reaction, if not controlled this temperature can increase up to burn the core and the shell of the part casted.

In this embodiment, the temperature shall not rise above about 150° C.

These temperatures depend on the nature of the curable liquid resin and polymerization initiator, and may be easily determined by general knowledge of one of ordinary skill in the art.

2. Step of Mixing the Operable Curable Liquid Resin with the Micro-Elements

The temperature of mixing the operable curable resin and the micro-element may be regulated, if necessary, to control and limit the exothermic peak. The temperature may be maintained between 15 and 60° C., for example of from 17° C. to 45° C., for example 20 to 40° C., depending on the nature of the resin/polymerization initiator.

3. Step of Homogenizing and Degasing the Mixture of Operable Curable Liquid Resin and Micro-Elements

The temperature of homogenization and degassing may be regulated, if necessary, to control and limit the exothermic peak. The temperature may be maintained between 15 and 50° C., for example of from 17° C. to 45° C., for example 20 to 40° C., depending on the nature of the resin/polymerization initiator.

4. Step of Casting the Intermediate Syntactic Foam in the Container

The temperature of casting the intermediate syntactic foam in the container may be regulated, if necessary, to control and limit the exothermic peak. The temperature may be maintained between 15 and 50° C., for example of from 17° C. to 45° C., for example 20 to 40° C., depending on the nature of the resin/polymerization initiator.

5. Step of Hardening the Operable Curable Liquid Resin

The hardening of the operable curable liquid resin may be achieved by heating the resin, at a temperature comprised from 15 and 50° C., for example of from 17° C. to 45° C., for example 20 to 40° C. In one embodiment, the temperature is handled in order to control and limit the exothermic peak.

### Example 8: Calculation Examples of Buoyancy

1. Cuboid Shape

This example will take into account a cuboid shape buoyancy with edges of 1 m (a, height), 2 m (b, width) and 1.5 m (c, depth).

Recipe Choice

Parameters are:

| Volumic ratio of | Volumic ratio of | Volumic ratio of |
|---|---|---|
| resin | hardener | μspheres |
| ratioᵣₑₛᵢₙ = 26.6% | ratio_{hardener} = 18.4% | ratio_{μsph} = 55% |
| Resin density | Hardener density | μspheres density |
| ρᵣₑₛᵢₙ = 1140 kg/m³ | ρ_{hardener} = 970 kg/m³ | ρ_{μsph} = 200 kg/m³ |

Process factor γ_{process}=1.05

Macrospheres diameter D_{Msph}=25.4 mm

Macrospheres density ρ_{Msph}=363 kg/m³

Shell Volume and Calculation of the Volume Affected by the Wall:

$${V}_{shell} = a \times b \times c = 1 \times 2 \times 1 , 5 = 3 {m}^{3}$$

$${V}_{closed packed} = ( ( a - 2 \times \frac{{D}_{Msph}}{2} ) \times ( b - 2 \times \frac{{D}_{Msph}}{2} ) \times ( c - 2 \times \frac{{D}_{Msph}}{2} ) ) = 2.84 {m}^{3}$$

$${V}_{wall affected} = {V}_{shell} - {V}_{closed packed} = 0.162 {m}^{3}$$

% Macrosphere Calculation:

$$ratioMsph = \frac{{V}_{wall affected}}{{V}_{shell}} \times ( 1 - {\%}_{porosity wall affected} ) + \frac{{V}_{closed packed}}{{V}_{shell}} \times ( 1 - {\%}_{porosity close packed} ) = 62.9 \%$$

Density Calculation:

$${ρ}_{syntactic foam} = {γ}_{Process} \times ( {\%}_{Volume hardener} \times {ρ}_{hardener} + {\%}_{Volume μ sph} \times {ρ}_{μ sph} + {\%}_{Volume resin} \times {ρ}_{resin} ) = 620 kg \text{/} {m}^{3}$$

$${ρ}_{COMPOSITE SYNTACTIC FOAM} = {ratio}_{Msph} \times {ρ}_{Msph} + ( 1 - {ratio}_{Msph} ) \times {ρ}_{syntactic foam} = 458 kg \text{/} {m}^{3}$$

2. Cylindrical Shape

This example takes into account a cylindrical shape buoyancy with a diameter (a) of 2 m and a height (b) of 3 m, for a design depth of 500 m.

Recipe Choice

Parameters are:

| Volumic ratio of | Volumic ratio of | Volumic ratio of |
|---|---|---|
| resin | hardener | μspheres |
| ratioᵣₑₛᵢₙ = 26.6% | ratio_{hardener} = 18.4% | ratio_{μsph} = 55% |
| Resin density | Hardener density | μspheres density |
| ρᵣₑₛᵢₙ = 1140 kg/m³ | ρ_{hardener} = 970 kg/m³ | ρ_{μsph} = 125 kg/m³ |

Process factor γ_{process}=1.12

Macrospheres diameter D_{Msph}=35.6 mm

Macrospheres density ρ_{Msph}=205 kg/m³

Shell Volume and Calculation of the Volume Affected by the Wall:

$${V}_{shell} = b \times ( π \times \frac{{a}^{2}}{4} ) = 9.425 {m}^{3}$$

$${V}_{closed packed} = ( b - 2 \times \frac{{D}_{Msph}}{2} ) \times π \times \frac{{( a - \frac{{D}_{Msph}}{2} )}^{2}}{4} = 9.15 {m}^{3}$$

$${V}_{wall affected} = {V}_{shell} - {V}_{closed packed} = 0.277 {m}^{3}$$

% Macrosphere Calculation:

$${\%}_{Volume Msph} = \frac{{V}_{wall affected}}{{V}_{shell}} \times ( 1 - {\%}_{porosity wall affected} ) + \frac{{V}_{closed packed}}{{V}_{shell}} \times ( 1 - {\%}_{porosity closed packed} ) = 63.4 \%$$

Density Calculation:

$${ρ}_{syntactic foam} = {γ}_{Process} \times ( {\%}_{Volume hardener} \times {ρ}_{Hardener} + {\%}_{Volume μ sph} \times {ρ}_{μ sph} + {\%}_{Volume resin} \times {ρ}_{resin} ) = 615 kg \text{/} {m}^{3}$$

$${ρ}_{COMPOSITE SYNTACTIC FOAM} = {\%}_{Volume Msph} \times {ρ}_{Msph} + ( 1 - {\%}_{Volume Msph} ) \times {ρ}_{syntactic foam} = 355 Kg kg \text{/} {m}^{3}$$

3. Buoyancy Module Shape

This kind of shape is the same kind of shape than distributed buoyancy modules (cf. FIG. 14 B), with:

a=0.4 m

b=0.1 m

c=0.5

Parameters are:

| Volumic ratio of | Volumic ratio of | Volumic ratio of |
|---|---|---|
| resin | hardener | μspheres |
| %_{Volume resin} = 26.6% | %_{Volume hardener} = 18.4% | %_{Volume μsph} = 55% |
| Resin density | Hardener density | μspheres density |
| ρᵣₑₛᵢₙ = 1140 kg/m³ | ρ_{hardener} = 970 kg/m³ | ρ_{μsph} = 200 kg/m³ |

Process factor γ_{process}=1.048

Macrospheres diameter D_{Msph}=25.4 mm

Macrospheres density ρ_{Msph}=363 kg/m³

Shell Volume and Calculation of the Volume Affected by the Wall:

$${V}_{shell} = \frac{c}{2} \times \frac{( {a}^{2} - {b}^{2} ) \times π}{4} = 0.029 {m}^{3}$$

$${V}_{closed packed} = \frac{( {( a - \frac{{D}_{Msph}}{2} )}^{2} - {( b - \frac{{D}_{Msph}}{2} )}^{2} ) \times \frac{π}{4} \times ( c - 2 \times \frac{{D}_{Msph}}{2} )}{2} - ( ( a - b - {D}_{Msph} ) \times ( c - {D}_{Msph} ) \times {D}_{Msph} ) = 0.023 {m}^{3} {V}_{wall affected} = {V}_{shell} - {V}_{closed packed} = 0.006 {m}^{3}$$

% Macrosphere Calculation:

$${\%}_{Volume Msph} = \frac{{V}_{wall affected}}{{V}_{shell}} \times ( 1 - {\%}_{porosity wall affected} ) + \frac{{V}_{closed packed}}{{V}_{shell}} \times ( 1 - {\%}_{porosity close packed} ) = 59.8 \%$$

Density Calculation:

$${ρ}_{syntactic foam} = {γ}_{Process} \times ( {\%}_{Volume hardener} \times {ρ}_{hardener} + {\%}_{Volume μ sph} \times {ρ}_{μ sph} + {\%}_{Volume resin} \times {ρ}_{resin} ) = 620 kg \text{/} {m}^{3}$$

$${ρ}_{COMPOSITE SYNTACTIC FOAM} = {\%}_{Volume Msph} \times {ρ}_{Msph} + ( 1 - {\%}_{Volume Msph} ) \times {ρ}_{syntactic foam} = 466 kg \text{/} {m}^{3} kg \text{/} {m}^{3}$$

### LIST OF REFERENCES

1. U.S. Pat. No. 3,622,437.
2. Ben Aïm and Le Goff, “Effet de paroi dans les empilements désordonnés de sphères et application à la parasité de mélanges binaires”, Powder Technol, 1 (1967/68) 281-290.

1. A process for making a syntactic foam comprising:
a) mixing together a determined amount of a curable liquid resin monomer or prepolymer and a polymerization initiator in order to obtain an operable curable liquid resin;
b) mixing at a determined temperature range the operable curable liquid resin with a determined amount of at least one type of low density micro-elements, said micro-elements being comprised in a sphere having a diameter comprised from 1 μm to 1 mm and being introduced continuously in the operable curable liquid resin and at a constant volumetric and/or mass flow rate, while limiting breakage of micro-elements;
c) homogenizing at a determined temperature range and degassing the mixture of operable curable liquid resin and micro-elements in order to obtain an intermediate syntactic foam;
d) casting at a determined temperature range the intermediate syntactic foam in a container optionally comprising a determined amount of macro-elements being comprised in a sphere of a diameter comprised from 1 mm to 10 cm; and
e) hardening the operable curable liquid resin;
wherein the temperature is regulated, in one or more of step(s) a) to e), to control and limit exothermic peak during step e),
thereby obtaining the syntactic foam within the container.

2. The process according to claim 1, which is a continuous flow process.

3. The process according to claim 1, wherein the mixing of step a) is carried out by a mean of incorporating a solid phase into a liquid phase.

4. The process according to claim 3, wherein said mean is selected from the group comprising an endless screw, and a dispersing machine.

5. The process according to claim 1, in which said curable liquid resin is selected in the group comprising an epoxy resin, an epoxy bisphenol A diglycidyl ether based resin and a polyurethane resin.

6. The process according to claim 1, wherein the polymerization initiator is selected in the group comprising polyfunctional amines, acids, phenols, alcohols, thiols, polyols.

7. The process according to claim 1, wherein in step a), the ratio of epoxy resin monomer to polymerization initiator is comprised from 1 to 10.

8. The process according to claim 1, wherein the mixing of step b) is carried out by a mean selected from the group comprising an endless screw and a dispersing machine.

9. The process according to claim 1, wherein the mean temperature of step a) is of from 15 to 80° C.

10. The process according to claim 1, wherein the amount of microspheres in step b) is comprised from 10% to 65% in volume ratio in the syntactic foam.

11. The process according to claim 1, wherein the micro-elements are selected from the group comprising glass, ceramic, polymer, metal and carbon.

12. The process according to claim 1, wherein the constant volumetric and/or massic flow rate of step b) is comprised of from 5 to 30 kg/min and/or from 30 to 60 Kg/min.

13. The process according to claim 1, wherein the mixing of step c) is carried out by a mean selected from the group comprising an endless screw and a powder disperser.

14. The process according to claim 1, wherein the temperature of step c) is comprised from 10 to 80° C.

15. The process according to claim 1, wherein the determined mechanical force of step c) is selected from a shear force and an homogenization force resulting in less than 15% of breakage of the micro-elements.

16. The process according to claim 1, wherein the determined vacuum of step c) has a value less than the atmospheric pressure.

17. The process according to claim 1, wherein the macro-elements are macro-spheres and the micro-elements are micro-spheres.

18. The process according to claim 1, wherein the macro-elements are made in a material selected from a thermosetting resin such as an epoxy resin or a polyester resin, a thermoplastic resin such as polyethylene, ceramic and steel.

19. The process according to claim 1, wherein the temperature of step d) is maintained at a temperature that causes no damage to the syntactic foam.

20. The process according to claim 1, wherein the volume of syntactic foam casted into the container is greater than 1 liter.

21. The process according to claim 1, wherein the casting of step d) is realized in several successive castings.

22. The process according to claim 1, wherein step e) of hardening the operable curable liquid resin is realized at a temperature that causes no damage to the macro-elements.

23. The process according to claim 1, wherein the steps a) to e) are carried out in a batch or a continuous flow process.

24. The process according to claim 1, wherein the obtained syntactic foam has a density of from 200 kg/m³ to 800 kg/m³.

25. The process according to claim 1, wherein the buoyancy of the syntactic foam is defined according the principle (I):
Buoyancy=V_{Shell}×(ρ_{fluid}−ρ_{COMPOSITE SYNTACTIC FOAM}) (I)
wherein:
ρ_{COMPOSITE SYNTACTIC FOAM}=%_{Volume Macrosphere}×ρ_{Macrosphere}+%_{Volume Experimental syntactic foam}×ρ_{Experimental syntactic foam}
ρ_{Experimental syntactic foam}=γ_{Process}×(%_{Volume Hardener}×ρ_{Hardener}+%_{Volume μsphere}×ρ_{μsphere}%_{Volume Resin}×ρ_{Epoxy})
γ_{process} is the factor taking into account: process loss, remaining void in the matrix, shrinkage during polymerization, microsphere breakage ratio. ••%_{Volume Macrosphere} Calulation:
$${\%}_{Volume Macrosphere} = 1 - {\%}_{porosity} = \frac{{V}_{wall affected}}{{V}_{shell}} \times ( 1 - {\%}_{porosity affected by the wall} ) + \frac{{V}_{closed packed}}{{V}_{shell}} \times ( 1 - {\%}_{porosity close packed} )$$
V_{wall affected} is the volume occupied by all halves marcospheres in contact with the shell.
V_{closed packed}=Vₛₕₑₗₗ−V_{wall affected}

26. The process according to claim 1, wherein the volume percent of macro-element is from 10 to 99% in the resin.

27. A process for manufacturing a buoyancy material comprising an outer shell and a syntactic foam, the manufacturing process comprising:
a) mixing together a determined amount of a curable liquid resin monomer or prepolymer and a polymerization initiator in order to obtain an operable curable liquid resin;
b) mixing at a determined temperature range the operable curable liquid resin with a determined amount of at least one type of low density micro-elements, said micro-elements being comprised in a sphere having a diameter comprised from 1 μm to 1 mm and being introduced continuously in the operable curable liquid resin and at a constant volumetric and/or mass flow rate, while limiting breakage of micro-elements;
c) homogenizing at a determined temperature range and degasing the mixture of operable curable liquid resin and micro-elements in order to obtain an intermediate syntactic foam;
d) casting at a determined temperature range the intermediate syntactic foam in a container optionally comprising a determined amount of macro-elements being comprised in a sphere of a diameter comprised from 1 mm to 10 cm; and
e) hardening the operable curable liquid resin;
wherein the temperature is regulated, in one or more of step(s) a) to e), to control and limit exothermic peak during step e),
wherein the container determines the outer shell of the buoyancy, thereby obtaining the buoyancy material.

28. The process according to claim 27, which is a continuous flow process.

29. The process according to claim 27, wherein the mixing of step a) is carried out by a mean of incorporating a solid phase into a liquid phase.

30. The process according to claim 29, wherein said mean is selected from the group comprising an endless screw, and a dispersing machine.

31. The process according to claim 27, in which said curable liquid resin is selected in the group comprising an epoxy resin, an epoxy bisphenol A diglycidyl ether based resin and a polyurethane resin.

32. The process according to claim 27, wherein the polymerization initiator is selected in the group comprising polyfunctional amines, acids, acid anhydrides, phenols, alcohols, thiols.

33. The process according to claim 27, wherein in step a), the ratio of epoxy resin monomer to polymerization initiator is comprised from 1 to 10.

34. The process according to claim 27, wherein the mixing of step b) is carried out by a mean selected from the group comprising an endless screw and a dispersing machine.

35. The process according to claim 27, wherein the mean temperature of step a) is of from 5 to 80° C.

36. The process according to claim 27, wherein the amount of microspheres in step b) is comprised from 10% to 73% in volume ratio in the syntactic foam.

37. The process according to claim 27, wherein the micro-elements are selected from the group comprising glass, ceramic, polymer, metal and carbon.

38. The process according to claim 27, wherein the constant volumetric and/or mass flow rate of step b) is comprised of from 5 to 30 kg/min and/or from 30 to 60 Kg/min.

39. The process according to claim 27, wherein the mixing of step c) is carried out by a mean selected from the group comprising an endless screw and a powder disperser.

40. The process according to claim 27, wherein the temperature of step c) is comprised from 10 to 80° C.

41. The process according to claim 27, wherein the determined mechanical force of step c) is selected from a shear force and an homogenization force resulting in less than 20% of breakage of the micro-elements.

42. The process according to claim 27, wherein the determined vacuum of step c) has a value less than the atmospheric pressure.

43. The process according to claim 27, wherein the macro-elements are macro-spheres and the micro-elements are micro-spheres.

44. The process according to claim 27, wherein the macro-elements are made in a material selected from a thermosetting resin such as an epoxy resin or a polyester resin, a thermoplastic resin such as polyethylene, ceramic and steel.

45. The process according to claim 27, wherein the temperature of step d) is maintained at a temperature that causes no damage to the syntactic foam.

46. The process according to claim 27, wherein the volume of syntactic foam casted into the container is greater than 1 liter.

47. The process according to claim 27, wherein the casting of step d) is realized in several successive castings.

48. The process according to claim 27, wherein step e) of hardening the operable curable liquid resin is realized at a temperature that causes no damage to the macro-elements.

49. The process according to claim 27, wherein the steps a) to e) are carried out in a batch or a continuous flow process.

50. The process according to claim 27, wherein the obtained syntactic foam has a density of from 200 kg/m³ to 800 kg/m³.

51. The process according to claim 27, wherein the buoyancy of the syntactic foam is defined according the principle (I):
$$Buoyancy = {V}_{Shell} \times ( {ρ}_{fluid} - {ρ}_{COMPOSITE SYNTACTIC FOAM} ) \\ wherein \text{:} \\ {ρ}_{COMPOSITE SYNTACTIC FOAM} = {\%}_{Volume Macrosphere} \times {ρ}_{Macrosphere} + {\%}_{Volume Experimental syntactic foam} \times {ρ}_{Experimental syntactic foam} \\ {ρ}_{Experimental syntactic foam} = {γ}_{Process} \times ( {\%}_{Volume Hardener} \times {ρ}_{Hardener} + {\%}_{Volume μ sphere} \times {ρ}_{μ sphere} + {\%}_{Volume Resin} \times {ρ}_{Epoxy} ) \qquad ( I )$$
ρ_{process} is the factor taking into account process loss, remaining void in the matrix, shrinkage during polymerization and microsphere breakage ratio
$${\%}_{Volume Macrosphere} Calculation \text{:} {\%}_{Volume Macrosphere} = 1 - {\%}_{porosity} {\%}_{Volume Msphere} = \frac{{V}_{wall affected}}{{V}_{shell}} \times ( 1 - {\%}_{porosity affected by the wall} ) + \frac{{V}_{closed packed}}{{V}_{shell}} \times ( 1 - {\%}_{porosity close packed} )$$
V_{wall affected} is the volume occupied by all halves marcospheres in contact with the shell.
V_{closed packed}=Vₛₕₑₗₗ−V_{wall affected}

52. The process according to claim 50, wherein % Volume macro-element is from 50 to 99% in the resin.

53. The process according to claim 52, wherein the buoyancy material is manufactured to float at a distance from the surface of the sea of 200 m.

54. The process according to claim 52, wherein the buoyancy material is manufactured to float at a distance from the surface of the sea of 600 m.

55. The process according to claim 52, wherein the buoyancy material is manufactured to float at a distance from the surface of the sea of 4000 m.

56. The syntactic foam obtainable by the process accordingly to claim 1, including macro-elements dispersed in a mixture of a matrix comprising a curable liquid resin and low density microelements, in which said macro-elements are comprised in a sphere of a diameter comprised from 1 mm to 10 cm and said micro-elements being comprised in a sphere having a diameter comprised from 1 μm to 1 mm.

57. A buoyancy material comprising:
a syntactic foam obtainable by the process according to claim 1.

58. A buoyancy material obtainable by carrying out the process according to claim 27.

59. A process of undersea extraction of oil, comprising:
using a syntactic foam according to claim 1.

60. The process according to claim 59, wherein the syntactic or buoyancy material handles at a defined undersea level undersea extracting a pipeline.

61. An undersea extracting pipeline comprising:
a pipeline, and a syntactic foam as defined in claim 56.
